(19) United States
(12) Patent Application Publication
(10) Pub. No.: US 2007/0279524 A1
(43) Pub. Date: Dec. 6, 2007

(54) Information Multiplexing Device And Method, And Computer Program

(75) Inventor: Hirokazu Hirose, Saitama (JP)

Correspondence Address: YOUNG & THOMPSON, 745 SOUTH 23RD STREET, 2ND FLOOR, ARLINGTON, VA, 22202, US

(73) Assignee: Pioneer Corporation, Tokyo (JP)

(21) Appl. No.: 11/791,162

(22) PCT Filed: Nov. 17, 2005
(86) PCT No.: PCT/JP05/21118

§ 371 Date: Jul. 24, 2007

(30) Foreign Application Priority Data
Nov. 19, 2004 (JP) 2004-336614

(51) Int. Cl. H04N 9/00

(52) U.S. Cl. 348/468; 348/E09.001

(57) ABSTRACT

An information multiplexing device (100) includes: (i) extraction means (105, etc.) for extracting a closed caption (CC) signal superimposed for holding character information during a vertical retrace erase period; (ii) measurement means (113) for measuring actual data amount of character information (CC) from the extracted CC signal according to a predetermined cycle unit (GOP); (iii) superposition means (113, etc.) for superposing additional information (CGMS/A); (iv) judgment means (113) for judging whether it is possible to superimpose additional information, according to the allowed data amount of character information which can be held in the GOP and the actual data amount measured; and (v) control means for controlling the superposition means so as to superpose the additional information if the judgment results in that the additional information can be superposed.

### TECHNICAL FIELD

The present invention relates to an information multiplexing apparatus and method for multiplexing additional information, such as, e.g., copyright protection information (CGMS-A: Copy Generation Management System-Analog) and character information (XDX: eXtended Data Service), with respect to information, such as a video signal, and a computer program executed on the information multiplexing apparatus.

### BACKGROUND ART

Television (hereinafter abbreviated to “TV”) receivers with a screen size of 13 inches or more, based on the standard of NTSC (National Television System Committee) in North America, have a function of displaying the additional information, such as character information about broadcast narration, conversations, and broadcast content, on the TV receiver screens, for the hearing impaired. This function is generally referred to as a closed caption function (hereinafter the closed caption is referred to as “CC”, as occasion demands). In particular, in the present invention, the additional information transmitted by the closed caption function is referred to as “CC data”, as occasion demands. In the United States, the government legislated for CC decoders built in TV receivers on Jul. 1, 1993, and since then, the TV receivers with built-in CC decoders have been widely used.

In particular, in addition to this CC function, the PBS (Public Broadcasting Service) including the XDS (extended Data Service) started in April, 1994, in six cities of New York, Chicago, Los Angeles, San Francisco, Dallas, and Miami. This XDS functions as (i) a clock indicating a current time point, program start (end) time, program elapsed time, program remaining time, program delay time, and the like, (ii) a program guide indicating a program title, program detailed information, and the like, and (iii) a public service indicating emergency weather information. In the present invention, the XDS denotes the XDS as a service, and also denotes the additional information transmitted by this service.

On the other hand, for the purpose of content copyright protection, for example, an encryption system, such as CSS (Content Scrambling System), is realized on the basis of the DVD-Video standard. The CSS is an encryption system intended to prevent direct copying of a video file from an optical disc, such as a DVD. In order to perform allowance, rejection, or copy generation management of the copying of digital (analog) contents, CGMS (Copy Generation Management System) is defined.

In particular, there is also invented a method of superimposing the additional information, such as copyright protection information based on CGMS-A (Copy Generation Management System Analog), which is the CGMS for analog, in line 21 of a video signal of the NTSC standard, on the basis of the XDS.

Namely, in order to avoid the collision between the CC data and the superimposition of the CGMS-A based on the XDS, a memory device is provided. Specifically, for example, the memory device, such as a buffer memory, is provided for an output device, such as a TV signal encoder, which outputs the character information including the CGMS-A. Then, if the CC data is outputted in the course of the output of the CGMS-A, the output of the CGMS-A is suspended, and the CC data is outputted in priority.

### DISCLOSURE OF INVENTION

### Subject to be Solved by the Invention

However, generally, in order to superimpose the additional information, such as the CGMS-A, on the basis of the above-mentioned XDS, for example, it is necessary to detect a free space portion with a free space of several bytes or more. For this detection, for example, it is necessary to store or accumulate the character information, such as the CC data, including the additional information by a frame unit in a buffer memory. The output of the CC data is delayed by the stored amount. In other words, in order to avoid the collision between the CC data and the superimposition of the additional information, such as the CGMS-A and XDS, for example, both timing of displaying the CC data, such as captions or subtitles, and timing of displaying the additional information are delayed. Moreover, the buffer memory is provided for the output device, and the output of the CC data is suspended. Thus, the output control becomes complicated, which causes such a technical problem that it is hard to realize the appropriate superimposition of the additional information.

It is therefore an object of the present invention to provide an information multiplexing apparatus and method, which can appropriately and quickly multiplex the additional information, such as the CGMS-A and XDS, with respect to information, such as a video signal, and a computer program.

### Means for Solving the Subject

(Information Multiplexing Apparatus)

The above object of the present invention can be achieved by an information multiplexing apparatus provided with: an extracting device (decoder) for extracting (decoding) a closed caption signal, which is superimposed to hold character information, in a vertical blanking interval (VBI) of a video signal; a measuring device for measuring an actual data amount of the character information (CC) from the extracted closed caption signal, on the basis of a predetermined cycle unit (e.g. a cycle corresponding to 30 frames which constitute a GOP) of the video signal; a superimposing device for superimposing additional information (copyright protection information, CGMS/A, XDS) added to the video signal, on the video signal; a judging deice for judging whether or not the additional information (e.g. 7 frames) can be superimposed, on the basis of an allowable data amount (e.g. data amount corresponding to 30 frames) of the character information which can be held in the predetermined cycle unit (the cycle corresponding to the GOP) and the measured actual data amount (e.g. 20 frames); and a controlling device for controlling the superimposing device to superimpose the additional information in a position (latter-half frames in the GOP) where the closed caption signal can be provided in the predetermined cycle unit (GOP) if the additional information can be superimposed as a result of the judgment.

According to the information multiplexing apparatus of the present invention, firstly, for example, the CC signal is extracted (decoded or deciphered) by the extracting device for decoding (or deciphering) images, such as a MPEG decoder.

Then, by virtue of the measuring device, the actual data amount of the character information, such as the CC data, is measured from the extracted CC signal, on the basis of the predetermined cycle unit. Here, the “predetermined cycle unit” in the present invention is a cycle which uses, as a unit, a motion picture which is defined by a compression standard and which can be reproduced solo. More specifically, it is a cycle which uses, as a unit, a motion picture, such as 1GOP (Group Of Picture), which is provided with 30 frames.

Then, by virtue of the judging device, it is judged whether or not the additional information, such as the CGMS-A and XDS, can be superimposed, on the basis of (i) the allowable data amount of the character information which can be held in the predetermined cycle unit, such as 1GOP, and (ii) the measured actual data amount of the character information.

Then, as a result of the judgment, if the additional information can be superimposed, then, for example, under the control of the controlling device, such as a CPU (Central Processing Unit), the superimposing device superimposes the additional information, such as the CGMS-A and XDS, in the position, such as line 21, where the CC signal can be provided in the predetermined cycle unit.

As described above, in the present invention, it is judged whether or not the additional information, such as the CGMS-A and XDS, can be superimposed on the video signal, at the time point when the character information, such as the CC data, is obtained in the predetermined cycle unit, such as 1GOP of the video signal. On the result of the judgment, the additional information, such as the CGMS-A and XDS, is superimposed in the position where the CC signal can be provided in the predetermined cycle unit, such as 1GOP of the video signal.

As a result, for example, in superimposing the additional information, such as the CGMS-A and XDS, it is possible to almost or completely eliminate the delay of timing of displaying the character information, such as captions or subtitles.

In case of such a structure that a memory device, such as a buffer memory, is provided for an output device, such as a TV signal encoder, which outputs the character information, in order to avoid the collision between the character information and the superimposition of the additional information, if the character information is outputted in the course of the output of additional information, the output of the additional information is suspended, and the character information is outputted in priority. Thus, the superimposition of the additional information is suspended. If this suspension is performed, at least several frames of the character information in row need to be outputted. Then, after the frame holding the character information gets disconnected, the output of the additional information is restarted. Therefore, the timing of displaying the additional information and the timing of displaying the character information, such as captions or subtitles, are both delayed. Moreover, the memory device is provided for the output device, to thereby suspend the output of the character information. Thus, the output control becomes complicated, which makes it hard to appropriately realize the superimposition of the additional information.

In contrast, according to the present invention, it is judged whether the additional information, such as the CGMS-A and XDS, can be superimposed on the video signal, at the time point when the character information, such as the CC data, is obtained in the predetermined cycle unit, such as 1GOP of the video signal. On the basis of the result of the judgment, the additional information, such as the CGMS-A and XDS, is superimposed in the position where the CC signal can be provided in the predetermined cycle unit, such as 1GOP of the video signal.

As a result, for example, in superimposing the additional information, such as the CGMS-A and XDS, it is possible to almost or completely eliminate the delay of timing of displaying the character information, such as captions or subtitles. Thus, it is possible to realize the superimposition of the additional information, more appropriately and quickly.

Moreover, it is possible to constitute a memory device in existing legacy system, so it is not necessary to provide the memory device, such as a buffer memory, for storing the character information and detecting a free space portion (or free space position) in the output device in the TV signal encoder, for example. Thus, it is possible to realize the superimposition of the additional information, in a simpler structure. Thus, it is possible to further simplify the design and development of the information multiplexing apparatus.

In one aspect of the information multiplexing apparatus of the present invention, the judging device judges whether or not the additional information (XDS) can be superimposed, by comparing a free space (e.g. 10 frames) with an additional data amount (e.g. 7 frames) of the additional information, the free space being a difference between (i) the allowable data amount (the total amount of allocating the CC) in the predetermined cycle unit (GOP) and (ii) the actual data amount of the character information (CC), and the controlling device controls the superimposing device to superimpose the additional information in a free space portion (latter-half frame in the GOP) where the closed caption signal can be provided.

According to this aspect, the additional information is superimposed, on the basis of the comparison in magnitude between the additional data amount (e.g. 7 frames) and the free space (e.g. 10 frames) of the character information in the predetermined cycle unit, such as 1GOP, which is provided with 30 frames.

As a result, it is possible to accurately realize the superimposition of the additional information.

In an aspect associated with the judging device, the judging device may judge that the additional information can be superimposed if the difference is greater than the additional data amount.

By virtue of such construction, it is possible to accurately realize the superimposition of the additional information.

In another aspect of the information multiplexing apparatus of the present invention, the controlling device controls the superimposing device to superimpose the additional information in certain time intervals if the measured actual data amount is zero.

According to this aspect, it is possible to appropriately superimpose the additional information, whether the character information is superimposed in the predetermined cycle unit or not.

In another aspect of the information multiplexing apparatus of the present invention, the predetermined cycle unit is a GOP (Group Of Picture) based on MPEG (Moving Picture Experts Group phase) standard.

According to this aspect, it is possible to comply with an encryption system, such as CSS (Content Scrambling System), more appropriately.

In another aspect of the information multiplexing apparatus of the present invention, the additional information is information based on XDS (eXtended Data Service).

According to this aspect, it is possible to superimpose the additional information on the line 21 of the video signal of the NTSC standard.

In another aspect of the information multiplexing apparatus of the present invention, the additional information includes information for copyright protection of the video signal.

According to this aspect, it is possible to appropriately realize the copyright protection of video information, such as contents, held in the video signal.

In an aspect associated with the additional information, the additional information may include CCI (Copy Control Information).

According to this aspect, it is possible to realize allowance, rejection, or copy generation management of the copying of the video information, such as contents, held in the video signal, more appropriately.

In another aspect of the information multiplexing apparatus of the present invention, the additional information includes CDMS-A (Copy Generation Management System-Analog) information.

According to this aspect, it is possible to realize the copyright protection of the video information for analog.

(Information Multiplexing Method)

The above object of the present invention can be also achieved by an information multiplexing method provided with: an extracting process (decoder) of extracting (decoding) a closed caption signal, which is superimposed to hold character information, in a vertical blanking interval (VBI) of a video signal; a measuring process of measuring an actual data amount of the character information (CC) from the extracted closed caption signal, on the basis of a predetermined cycle unit (e.g. a cycle corresponding to 30 frames which constitute a GOP) of the video signal; a superimposing process of superimposing additional information (copyright protection information, CGMS/A, XDS) added to the video signal, on the video signal; a judging process of judging whether or not the additional information (e.g. 7 frames) can be superimposed, on the basis of an allowable data amount (e.g. a data amount corresponding to 30 frames) of the character information which can be held in the predetermined cycle unit (the cycle corresponding to the GOP) and the measured actual data amount (e.g. 20 frames); and a controlling process of controlling the superimposing device to superimpose the additional information in a position (latter-half frames in the GOP) where the closed caption signal can be provided in the predetermined cycle unit (GOP) if the additional information can be superimposed as a result of the judgment.

According to the information multiplexing method of the present invention, it is possible to receive the same various benefits as those of the above-mentioned information multiplexing apparatus of the present invention.

Incidentally, in response to the various aspects of the information multiplexing apparatus of the present invention described above, the information multiplexing method of the present invention can adopt various aspects.

(Computer Program)

The above object of the present invention can be also achieved by a computer program of instructions for multiplexing control and for tangibly embodying a program of instructions executable by a computer provided in the above-mentioned information multiplexing apparatus of the present invention (including its various aspects)the computer program making the computer function as at least one portion of the extracting device, the measuring device, the superimposing device, the judging device, and the controlling device.

According to the computer program of the present invention, the above-mentioned information multiplexing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the information multiplexing apparatus of the present invention described above, the computer program of the present invention can adopt various aspects.

The above object of the present invention can be also achieved by a computer program product in a computer-readable medium for tangibly embodying a program of instructions executable by a computer provided in the above-mentioned information multiplexing apparatus of the present invention (including its various aspects), to make the computer function as at least one portion of the extracting device, the measuring device, the superimposing device, the judging device, and the controlling device.

According to the computer program product of the present invention, the above-mentioned information multiplexing apparatus can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned information multiplexing apparatus.

These effects and other advantages of the present invention will become more apparent from the following embodiments.

As explained above, according to the information multiplexing apparatus of the present invention, it is provide with the extracting device, the measuring device, the superimposing device, the judging device, and the controlling device. According to the information multiplexing method of the present invention, it is provide with the extracting process, the measuring process, the superimposing process, the judging process, and the controlling process. Therefore, in superimposing the additional information, such as the CGMS-A and XDS, it is possible to almost or completely eliminate the delay of timing of displaying the character information, such as captions or subtitles.

Moreover, according to the computer program of the present invention, it makes a computer function as the above-mentioned information multiplexing apparatus of the present invention. Therefore, in superimposing the additional information, such as the CGMS-A and XDS, it is possible to almost or completely eliminate the delay of timing of displaying the character information, such as captions or subtitles.

### BRIEF DESCRIPTION OF THE DRAWINGS

FIG. 1 is a conceptual view schematically showing a video signal, a CC signal, a predetermined cycle unit of constituent elements (a frame and field), and a transmission time axis in the present invention.

FIG. 2 are timing charts schematically showing an odd field and an even field including the CC signals, and horizontal synchronizing signals corresponding to the fields, all of which constitute a composite video signal as one specific example of the video signal of the present invention.

FIG. 3 is a schematic diagram schematically showing the waveform and data amount of the CC signal of the present invention.

FIG. 4 is a block diagram showing the basic structure in an embodiment of the information multiplexing apparatus of the present invention.

FIG. 5 is a flowchart showing the operation principle in the embodiment of the information multiplexing apparatus of the present invention.

FIG. 6 is a conceptual view schematically showing the operation principle of the embodiment of the information multiplexing apparatus of the present invention, centered on the frames and GOPs.

FIG. 7 is a table showing transition on the transmission time axis of XDS outputted by a frame unit when a program title of a currently on-air program, which is one specific example of the additional information, displays “Star Trek” in the obtaining operation of the information multiplexing apparatus of the present invention.

FIG. 8 is a table showing control codes which constitute XDS which is one specific example of the additional information of the present invention.

FIG. 9 is a table showing type codes which constitute the XDS which is one specific example of the additional information of the present invention.

FIG. 10 is a table showing XDS which is another specific example of the additional information of the present invention.

FIG. 11 is a table showing type codes which constitute the XDS which is another specific example of the additional information of the present invention.

FIG. 12 is a table showing XDS which is another specific example of the additional information of the present invention.

FIG. 13 is a table showing XDS which is another specific example of the additional information of the present invention.

FIG. 14 is a table showing type codes which constitute the XDS which is another specific example of the additional information of the present invention.

FIG. 15 is a flowchart showing the operation principle in a comparison example.

FIG. 16 is a schematic diagram schematically showing the operation principle in the comparison example.

FIG. 17 is a table showing transition on the transmission time axis of XDS outputted by a frame unit when a program title of a currently on-air program, which is one specific example of the additional information, displays “Star Trek” in the obtaining operation of the information multiplexing apparatus in the comparison example.

### DESCRIPTION OF REFERENCE CODES

100 . . . information recording/reproducing apparatus, 101 . . . DVD, 102 . . . DVD drive, 103 . . . drive interface, 104 . . . demultiplexer, 105 . . . image decoder, 106 . . . audio decoder, 107 . . . thumbnail OSD, 108 . . . TV signal encoder, 109 (110) . . . D/A converter, 111 . . . video output, 112 . . . audio output, 113 . . . system CPU, 114 . . . operation device, 115 . . . memory device, 116 . . . remote-controlled light receiving device, and 117 . . . remote controller

### BEST MODE FOR CARRYING OUT THE INVENTION

Hereinafter, the best mode for carrying out the present invention will be discussed in order for each embodiment, with reference to the drawings.

Hereinafter, the embodiments of the present invention will be explained with reference to the drawings.

(1) Outline of Closed Caption Signal Superimposed on Line 21 of NTSC Standard

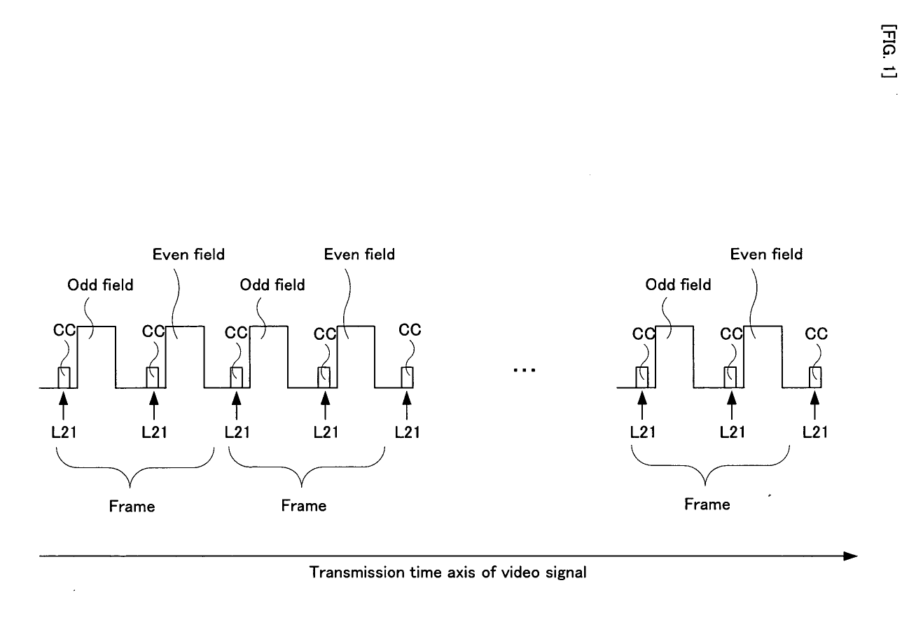

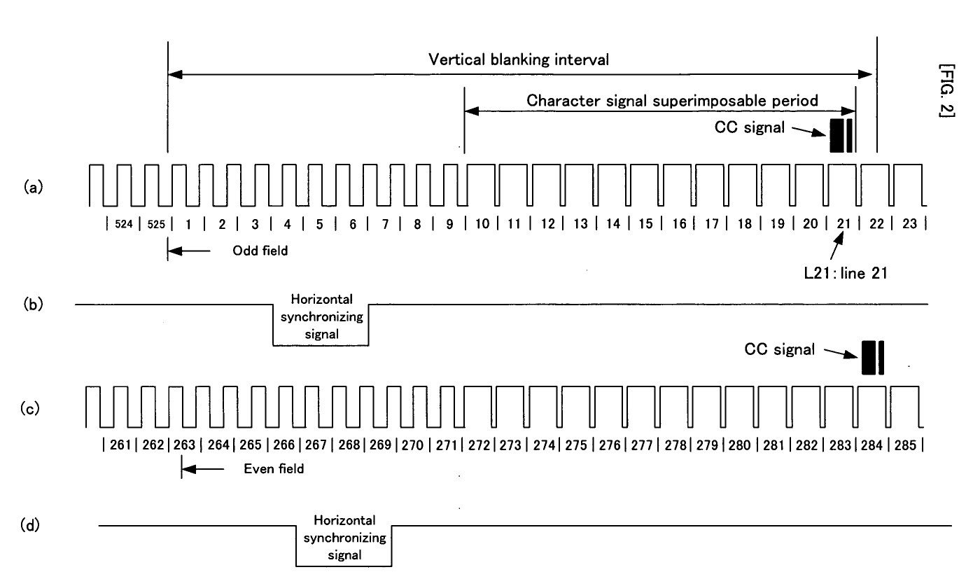

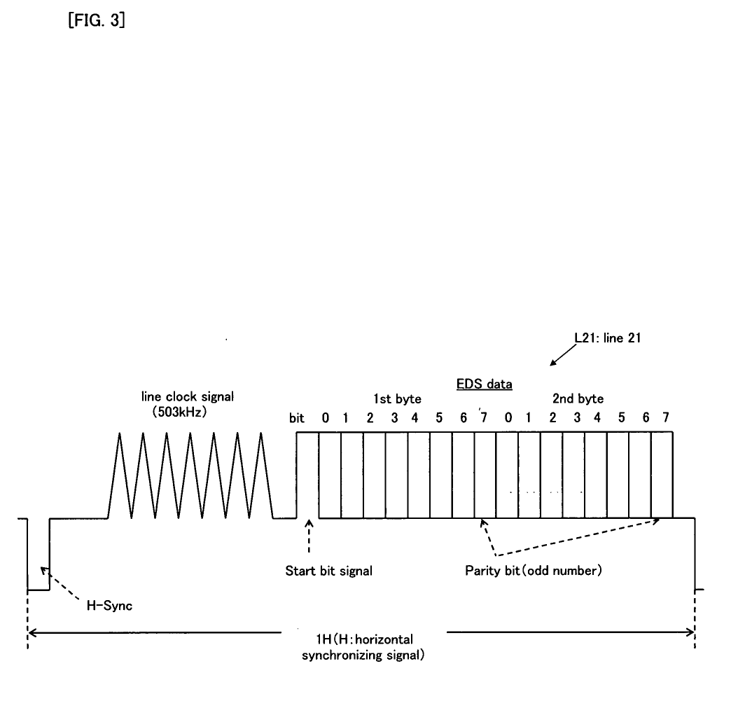

Firstly, with reference to FIG. 1 to FIG. 3, the outline of the closed caption signal of the present invention will be explained. Incidentally, in the embodiment, the closed caption is referred to as “CC”, as occasion demands. FIG. 1 is a conceptual view schematically showing a video signal, a CC signal, a predetermined cycle unit of constituent elements (a frame and field), and a transmission time axis in the present invention. FIG. 2 are timing charts schematically showing an odd field and an even field including the CC signals, and horizontal synchronizing signals corresponding to the fields, all of which constitute a composite video signal as one specific example of the video signal of the present invention. FIG. 3 is a schematic diagram schematically showing the waveform and data amount of the CC signal of the present invention.

As shown in FIG. 1, the CC signal is multiplexed, i.e. superimposed, by a cycle unit, such as a frame and a field, of the video signal on the transmission time axis. Then, if the video signal is an analog signal based on the NTSC method, the total number of scanning lines in one frame is 525, and the CC signal is multiplexed, i.e. superimposed, in the 21st horizontal scanning period, which is so-called line 21 (L21), among them.

Explaining fields which constitute a frame in detail, as shown in FIG. 2, the odd-numbered field of a composite video signal, which is one specific example of the video signal, is referred to an odd field, and the even-numbered field is referred to as an even field. Incidentally, the cycle of the field may be 1/60 seconds in accordance with the NTSC method as one example of the display method of a display. The cycle of the frame may be 1/30 seconds, which is twice as much as the field cycle. In general, as shown in FIG. 2(a), the CC signal is superimposed in the 21st horizontal scanning period from the start of VBI (Vertical Blanking Interval) of the odd field, i.e. line 21. At the same time, the CC signal may exist in the horizontal synchronizing signal shown in FIG. 2(b). Moreover, as shown in FIG. 2(c), another CC signal may be superimposed in the 284th horizontal scanning period of the even field in the composite video signal. At the same time, it may exist in the horizontal synchronizing signal shown in FIG. 2(d).

Explaining the line 21 (L21) in detail, as shown in FIG. 3, the CC signal superimposed on the line 21 (L21) is provided with: a line clock signal; a start bit signal; and an information signal holding a 16-bit data amount. More specifically, for example, seven cycles of line clock signals with 503 (kHz) are provided in order to synchronize the information signal after a burst signal. Then, the start bit signal is constructed from a 2-bit blanking level and 1 bit which indicates the start of the information signal, and subsequently, the information signal holding the 16-bit data amount is constructed.

Out of the 16-bit data amount, the first 7 bits indicate (i) control codes for specifying the class and function of the character information, such as definition, end, and start. The last 7 bits indicate (ii) type codes indicating the type of the character information. The remaining 1 bit constitutes a checksum for error detection. Incidentally, the control code and the type code will be detailed later.

As described above, the CC signal has the data amount of 16 bits (2 bytes). Thus, as shown in FIG. 1 described above, 2 characters of character information can be transmitted in 1 frame made of the odd field and the even field, i.e. in one picture. For example, in case of 30 frames per second, that is, if a transmission rate is 30 pictures per second, 480-bit (16 bits×30 pictures), i.e. 60 characters (2 characters×30 pictures) of character information can be transmitted in one second.

(2) Details of Embodiment of Information Multiplexing Apparatus

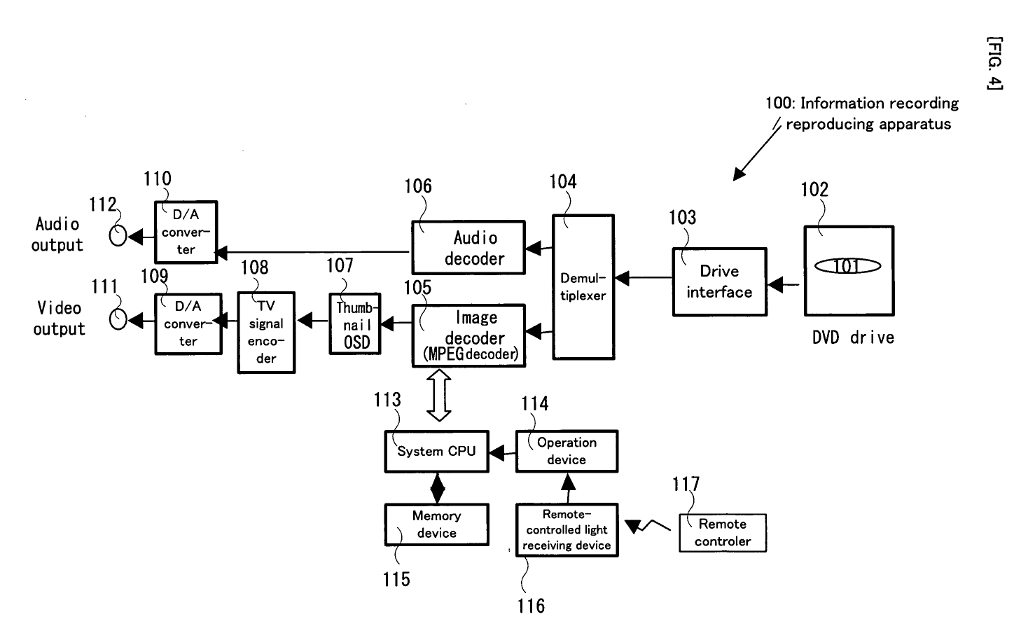

Next, with reference to FIG. 4 to FIG. 14, the basic structure and operation principle in the embodiment of the information multiplexing apparatus of the present invention will be explained.

(2-1) Basic Structure

Firstly, with reference to FIG. 4, the basic structure in the embodiment of the information multiplexing apparatus of the present invention will be explained. FIG. 4 is a block diagram showing the basic structure in the embodiment of the information multiplexing apparatus of the present invention. Incidentally, in the embodiment, an information recording/reproducing apparatus will be explained, as one specific example of the information multiplexing apparatus of the present invention.

As shown in FIG. 4, an information recording/reproducing apparatus 100, which is one specific example of the information multiplexing apparatus of the present invention, is provided with: a DVD 101; a DVD drive 102; a drive interface 103; a demultiplexer 104; an image decoder 105; an audio decoder 106; a thumbnail OSD 107; a TV signal encoder 108; a D/A (Digital to Analog) converters 109 and 110; a video output terminal 111; an audio output terminal 112; a system CPU 113; and operation device 114; a memory device 115; a remote-controlled light receiving device 116; and a remote controller 117. Incidentally, the D/A converter 109 may be built in the TV signal encoder 108.

(2-2) Operation Principle

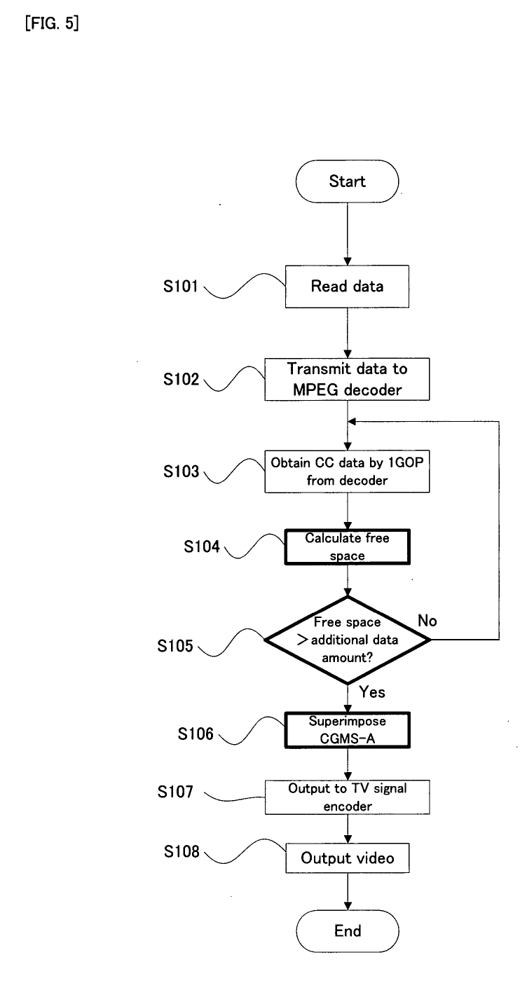

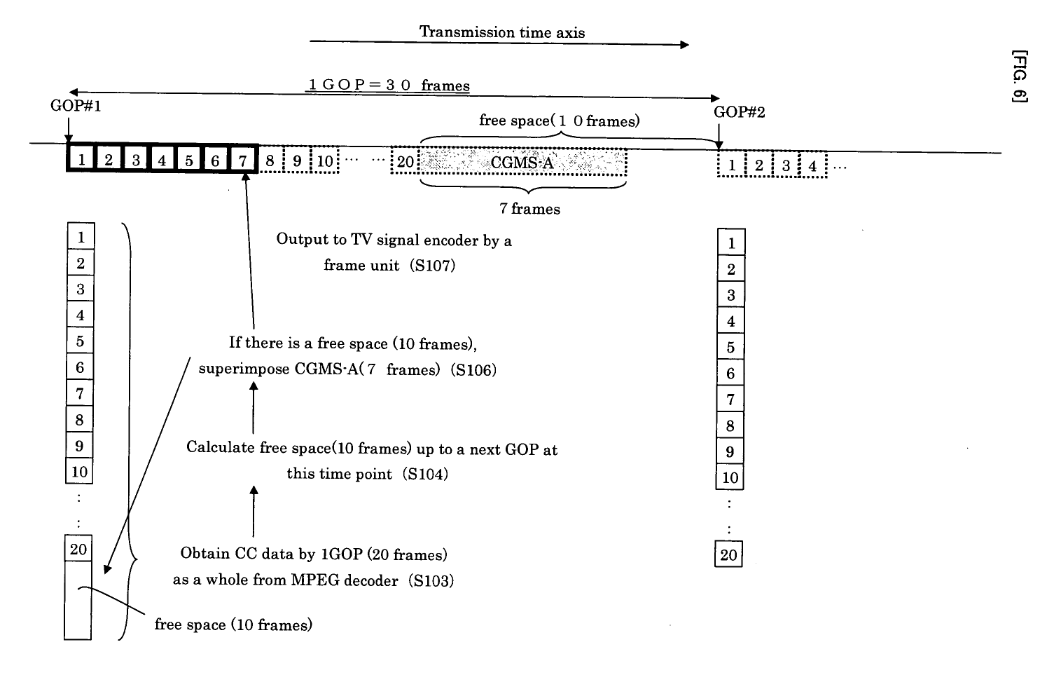

Next, with reference to FIG. 5 and FIG. 6, as well as FIG. 4 described above, as occasion demands, an explanation will be given the operation principle and the detailed structure in the embodiment of the information multiplexing apparatus of the present invention. FIG. 5 is a flowchart showing the operation principle in the embodiment of the information multiplexing apparatus of the present invention. FIG. 6 is a conceptual view schematically showing the operation principle of the embodiment of the information multiplexing apparatus of the present invention, centered on the frames and GOPs. Incidentally, in FIG. 6, one quadrilateral indicates one frame. Incidentally, in the embodiment, one GOP is provided with 30 frames (or pictures); however, in a compression method of MPEG 2 or MPEG 4, the number of frames (e.g., the number of pictures) which constitute one GOP can be arbitrarily set. Moreover, the upper part of FIG. 6 shows such a state that each frame is line-outputted on the transmission time axis. Moreover, in FIG. 6, the second GOP#2 is outputted following the first GOP#1.

The outline of the operation principle in the embodiment will be explained. The controlling device, such as, e.g. a system CPU, firstly compares (i) a free space (e.g. 10 frames), which is a difference between an allowable amount of data (e.g. 30 frames) which can be held in the GOP and an actual amount of data (e.g. 20 frames) of the character information (e.g., CC), with (ii) an additional amount of data (e.g. 7 frames) of the additional information (e.g., XDS).

Then, using the comparison result, it is judged whether or not the additional information (XDS) can be superimposed. If the free space is greater than the additional amount of data, the superimposing device superimposes the additional information in a free space portion where the CC signal can be provided (e.g. the latter-half frames in the GOP), under the control of the controlling device.

As shown in FIG. 5, firstly, the record information, such as contents, recorded in the optical disc 101 is read by the DVD drive 102 including an optical pickup or the like (step S 101).

Then, the read video information (or a video signal holding the video information) is decoded (or deciphered) by a MPEG decoder, such as the image decoder 105 and the audio decoder 106, and is outputted (or reproduced) to the controlling device, such as a CPU (step S102). Incidentally, the outputted video signal may be stored into a memory device, such as the memory device 115.

Then, under the control of the controlling device, such as a CPU, CC data (closed caption data: character information) is obtained by a predetermined cycle unit, such as 1GOP (Group Of Picture) made of, e.g. 30 frames, from the video signal outputted from the MPEG decoder 105 (106) (step S103). Incidentally, the obtained CC data may be stored into the memory device, such as the memory device 115.

More specifically, as shown in the step S103 in FIG. 6, the CC data in one GOP#1 made of, e.g. 30 frames, is obtained under the control of the controlling device, such as a CPU. As described above, if the reproduction is performed in the DVD-Video standard, the CC data can be obtained in the predetermined cycle unit, such as 1GOP.

Then, under the control of the controlling device, such as a CPU, the free space (e.g. 10 frames) is calculated which is a difference between (i) the allowable data amount (e.g. 30 frames) of the CC data that can be held in 1GOP and (ii) the actual data amount (e.g. 20 frames) of the obtained CC data (step S104). In other words, at the time point when the CC data is obtained, i.e., before the CC data is outputted to the TV signal encoder 108, it is possible to calculate the free space (e.g. 10 frames) which is a difference between (i) the allowable data amount (e.g. 30 frames) of the CC data that can be held in 1GOP corresponding to 30 frames and (ii) the actual data amount (e.g. 20 frames) of the CC data. Specifically, the allowable data amount of the CC data that can be held in 1GOP corresponding to 30 frames is 60(=2×30) bytes. Therefore, as shown in the step S104 in FIG. 6, it is possible to calculate the free space until the GOP#2 is line-outputted on the transmission time axis, by calculating the free space from the difference between (i) the allowable data amount and (ii) the actual data amount of the CC data at the time point when the CC data of the GOP#1 is obtained, under the control of the controlling device, such as a CPU.

Then, under the control of the controlling device, such as a CPU, it is judged whether or not the calculated free space is greater than the additional data amount of the additional information, such as the CGMS-A and XDS (step S105). Specifically, for example, if the additional data amount is the data amount of the CC data corresponding to 7 frames, the free space is 10 frames, as described above, so that the free space can be judged to be greater than the additional data amount. In this manner, under the control of the controlling device, such as a CPU, it can be judged whether or not there is the free space required for the superimposition of the additional information, such as the CGMS-A and XDS, at the time point when the CC data of the GOP#1 is obtained.

As a result of the judgment in the step S105, if the calculated free space is greater than the additional data amount (the step S105: Yes), the additional information, such as the CGMS-A and XDS, is superimposed in the free space portion (or free space position) where the closed caption signal holding the CC data can be provided in a tail portion in 1 GOP, for example, under the control of the controlling device, such as a CPU (step S106).

More specifically, as shown in the step S106 in FIG. 6, under the control of the controlling device, such as a CPU, the additional information, such as the CGMS-A and XDS, is superimposed in the free space portion subsequent to the 20th frame where the CC data is superimposed in one GOP#1 made of 30 frames, for example.

Then, under the control of the controlling device, such as a CPU, the video signal on which the additional information, such as the CGMS-A and XDS, is superimposed, is outputted to the TV signal encoder 108 (step S107). Incidentally, the video signal with the additional information superimposed may be outputted to the TV signal encoder 108 by a predetermined unit, such as 1 frame, for example. Incidentally, the predetermined unit may be a smaller unit, such as 1 field, for example.

More specifically, as shown in the step S107 in FIG. 6, under the control of the controlling device, such as a CPU, the frames constituting the GOP#1 on which the additional information (such as the CGMS-A and XDS) is superimposed, are line-outputted from the first frame in order, on the transmission time axis. Incidentally, FIG. 6 shows that the first to seventh frames are line-outputted.

Then, the TV signal encoder 108 outputs the video signal on which the additional information (such as the CGMS-A and XDS) is superimposed, towards the line 21 of the video output terminal (step S108).

More specifically, on the TV signal encoder 108, the video signal on which the additional information (such as the CGMS-A and XDS) is superimposed, is modulated to a brightness signal and a color signal. And the video signal I outputted toward the video output terminal 111.

On the other hand, as a result of the judgment in the step S105, if the calculated free space is not greater than the additional data amount (the step S105: No), then as described above, under the control of the controlling device, such as a CPU, the CC data is obtained in the predetermined cycle unit, such as 1GOP, from the video signal outputted from the MPEG decoder 105 (or 106).

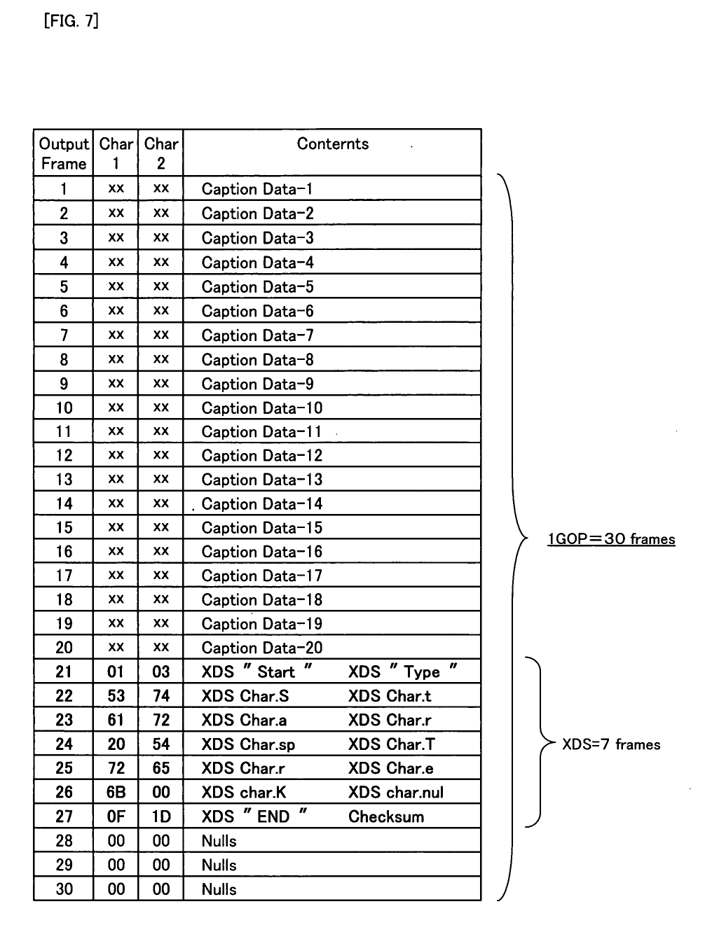

Now, with reference to FIG. 7 to FIG. 14, the obtaining operation of the information multiplexing apparatus of the present invention will be explained more specifically. FIG. 7 is a table showing transition on the transmission time axis of XDS outputted by a frame unit when a program title of a currently on-air program displays “Star Trek” which is one specific example of the additional information, in the obtaining operation of the information multiplexing apparatus of the present invention.

As shown in FIG. 7, under the control of the controlling device, such as a CPU, the data amount of the CC data (Caption Data-n: n is a natural number) superimposed over 20 frames, is obtained in “1GOP” that includes an “output frame #1” to an “output frame #30”.

Therefore, under the control of the controlling device, such as a CPU, the free space of the CC data by 1GOP unit is calculated, and it can be judged whether or not the additional information, such as the program title “Star Trek” of the currently on-air program, can be superimposed. On the basis of the judgment result, the additional information can be superimposed.

Specifically, it is possible to superimpose the XDS (eTended Data Service) on the 1GOP unit of video signal, in the “output frame #21” to the “output frame #27”. More specifically, in the “output frame #21”, a packet holding information about “control code, type code”=“01, 03” is transmitted, to thereby start the XDS.

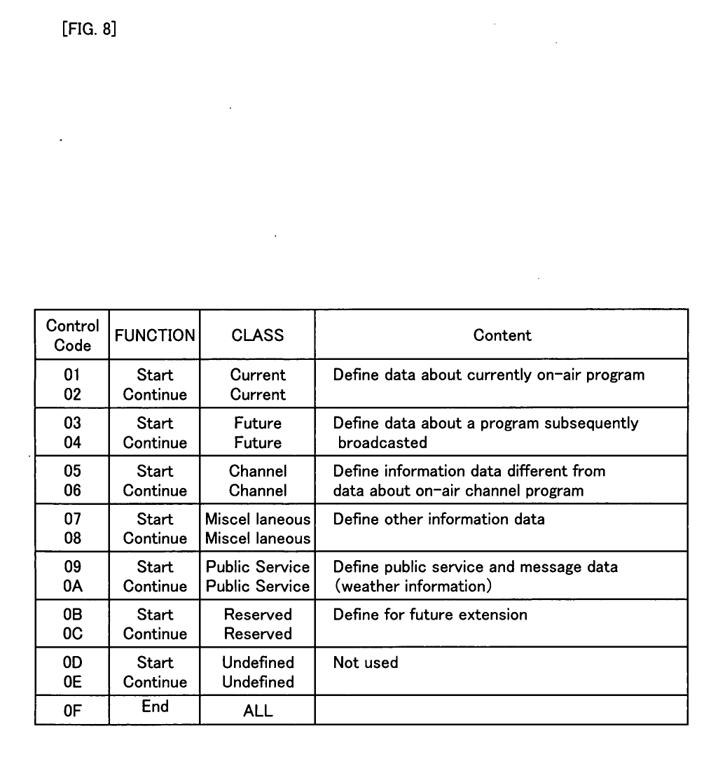

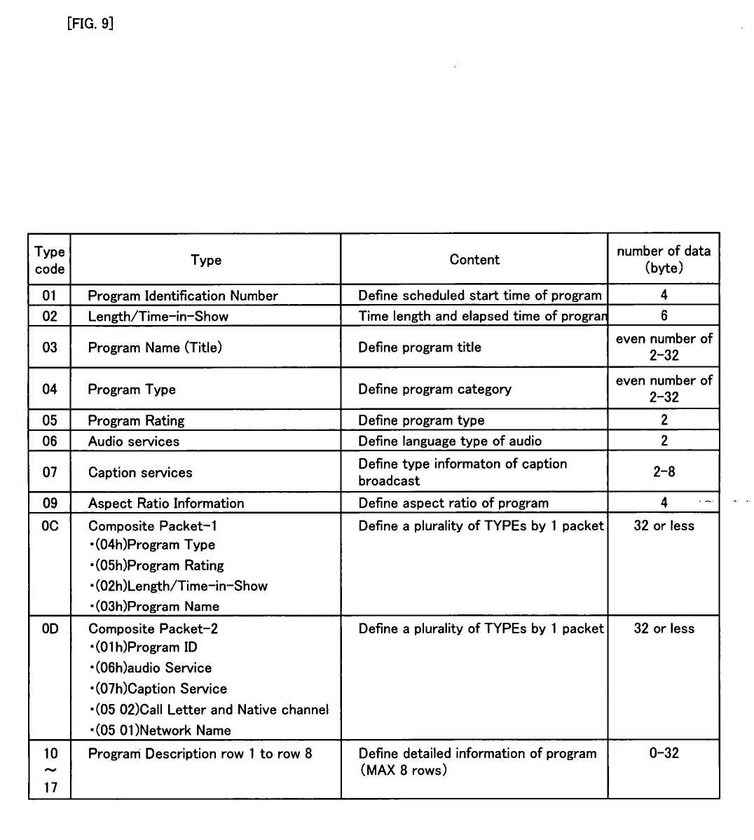

Now, with reference to FIG. 8 and FIG. 9, an explanation will be given for the control code and the type code, which constitute the XDS which is one specific example of the additional information of the present invention. FIG. 8 is a table showing control codes which constitute XDS which is one specific example of the additional information of the present invention. FIG. 9 is a table showing type codes which constitute the XDS which is one specific example of the additional information of the present invention.

As shown in FIG. 8, if the “control code” s “01”, “Current” is selected for the CLASS, and the output of the character information indicating the definition about the currently on-air program is started. If the “type code” is “03” for this control code, as shown in FIG. 9, “Program Name” is selected as the TYPE, and the program title is defined. Therefore, it is possible to output the character information indicating the program title of a data amount of even-numbered bytes out of 2 to 32 bytes, after the output frame #21.

Back in FIG. 7 again, and subsequently, in order to display the program title “Start Trek” of the currently on-air program, a character code is outputted from the “output frame #22” to the “output frame #26” in order. Incidentally, this character code may be based on the standard ASCII. Specifically, “character code, character code”=“53, 74” is transmitted in the “output frame #22”, to thereby display “S” and “t” of the program title. In the same manner, “character code, character code”=“61, 72” is transmitted in the “output frame #23”, to thereby display “a” and “r” of the program title. “Character code, character code”=“20, 54” is transmitted in the “output frame #24”, to thereby display “space” and “T” of the program title. “Character code, character code”=“72, 65” is transmitted in the “output frame #25”, to thereby display “r” and “e” of the program title. “Character code, character code”=“6B, 00” is transmitted in the “output frame #26”, to thereby display “k” and “zero (Null)” of the program title.

Lastly, a packet holding information about “Character code, character code”=“0F, 1D” is transmitted in the “output frame #27”, and the output of the XDS is ended. More specifically, since the “control code” is “0F” as described in FIG. 8 described above, the output of the XDS is ended. Moreover, a checksum value for detecting an error in the data of the XDS may be indicated by “1D” which is a value in the position of the “type code”.

In particular, as another specific example of the additional information, (i) Greenwich mean time, (ii) local time and DST (Daylight Saving Time: Summer time), and (iii) a broadcast station name and a channel number may be indicated.

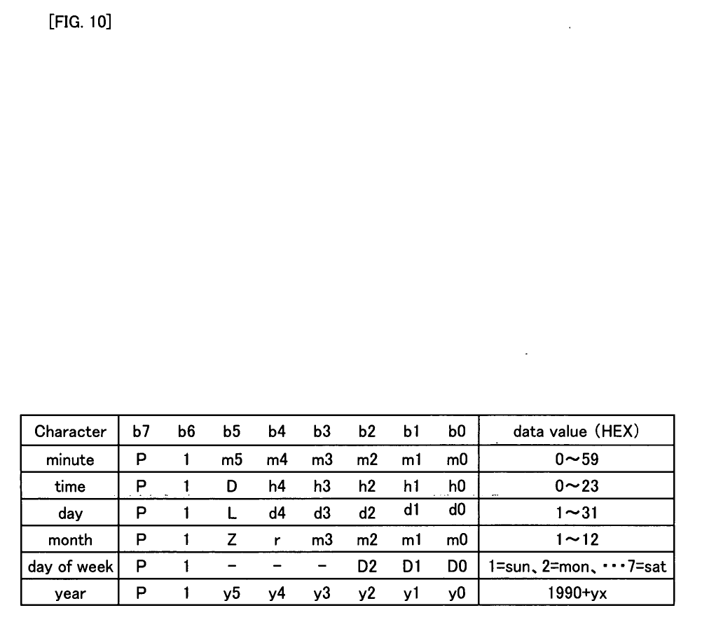

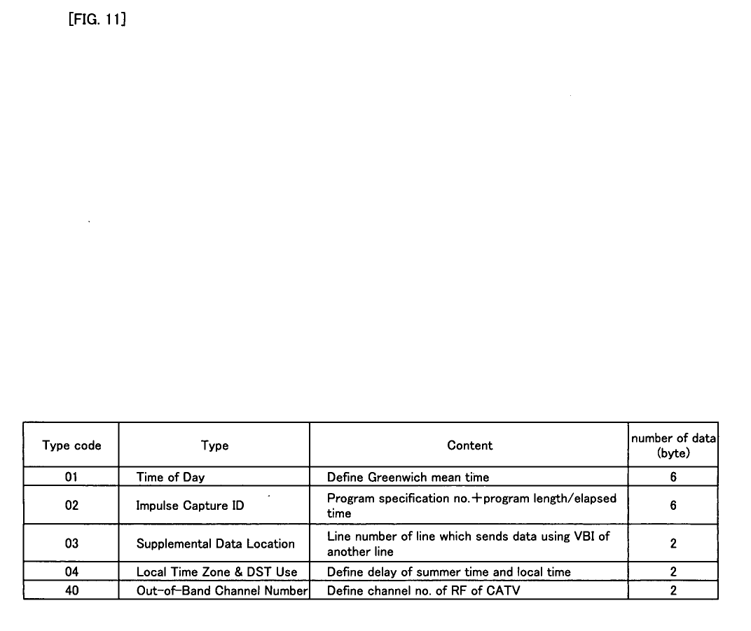

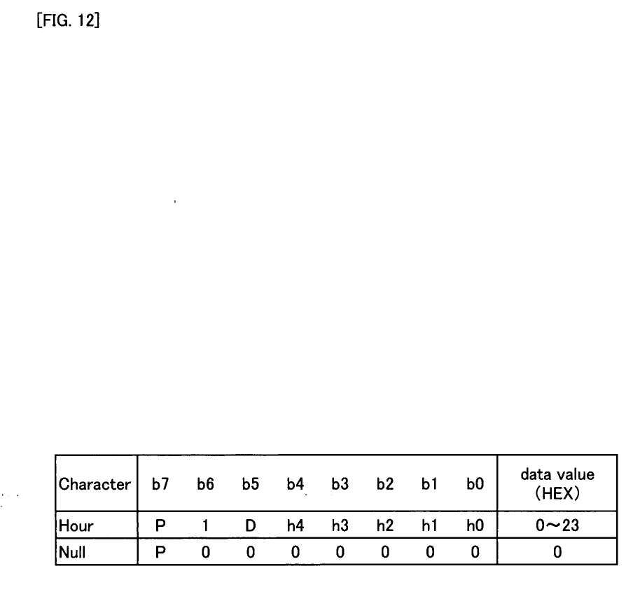

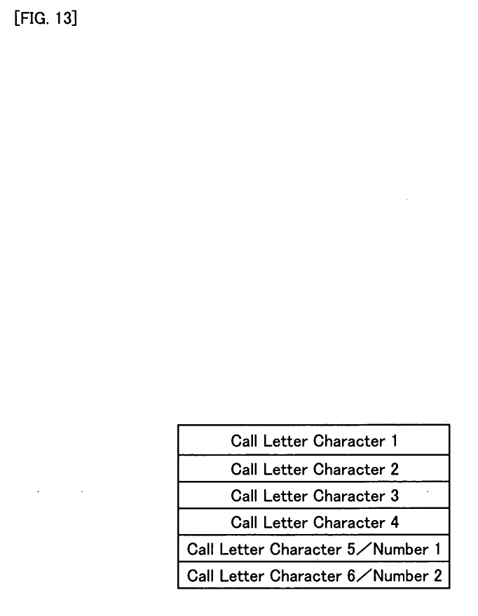

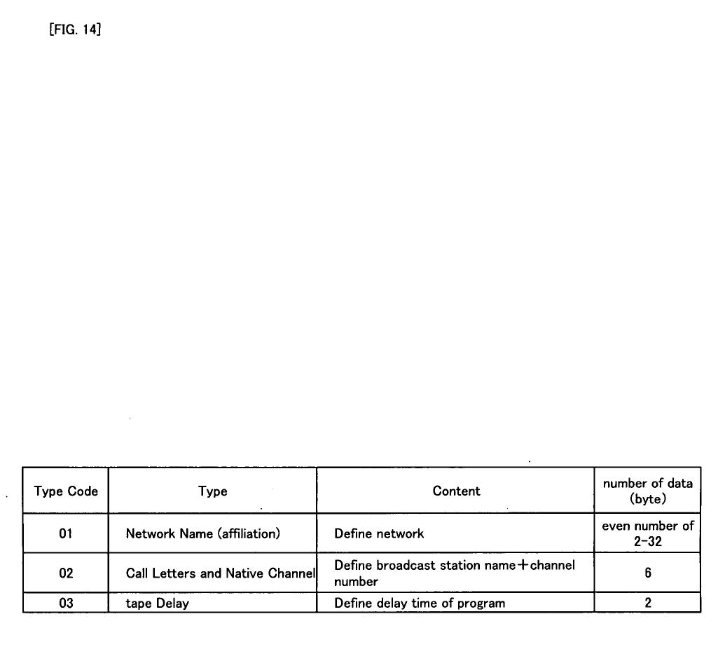

Now, with reference to FIG. 10 to FIG. 14, another specific example of the additional information of the present invention will be explained in more detail. FIG. 10 is a table showing XDS which is another specific example of the additional information of the present invention. FIG. 11 is a table showing type codes which constitute the XDS which is another specific example of the additional information of the present invention. FIG. 12 is a table showing XDS which is another specific example of the additional information of the present invention. FIG. 13 is a table showing XDS which is another specific example of the additional information of the present invention. FIG. 14 is a table showing type codes which constitute the XDS which is another specific example of the additional information of the present invention.

With regard to (i) Greenwich mean time, a packet holding information about “control code, type code”=“07, 01” is transmitted, to thereby start the XDS. Moreover, a packet holding information about “control code, type code”=“08, 01” is transmitted, to thereby continue the XDS. Specifically, it is possible to define Greenwich mean time by using “type code”=“01” shown in FIG. 11. Subsequently, it is possible to transmit the XDS holding information about “year”, “day of the week”, “month”, “day”, “hour”, and “minute” of Greenwich mean time, on the basis of the table shown in FIG. 10.

With regard to (ii) local time and DST, a packet holding information about “control code, type code”=“07, 04” is transmitted, to thereby start the XDS. Moreover, a packet holding information about “control code, type code”=“08, 04” is transmitted, to thereby continue the XDS. Specifically, it is possible to define the delay of Summer time and the local time by using “type code”=“04” shown in FIG. 11. Subsequently, it is possible to transmit the XDS holding information about the delay of Summer time and the local time of “time”, on the basis of the table shown in FIG. 12.

With regard to (iii) the broadcast station name and the channel number, a packet holding information about “control code, type code”=“05, 02” is transmitted, to thereby start the XDS. Moreover, a packet holding information about “control code, type code”=“06, 02” is transmitted, to thereby continue the XDS. Specifically, it is possible to define the broadcast station name and the channel number by using “type code”=“02” shown in FIG. 14. Subsequently, it is possible to transmit the XDS holding character information about the broadcast station name and the channel number, on the basis of the table shown in FIG. 13. Specifically, the first four characters from a character 1 to a character 4 may be an abbreviation for a network name. Moreover, if six characters from the character 1 to a character 6 are used, the last two characters may indicate a channel number allocated at a local broadcast station.

As a result, according to the embodiment, it is judged whether or not the additional information, such as the CGMS-A and XDS, can be superimposed on the video signal, at the time point when the CC data is obtained in the predetermined cycle unit, such as 1GOP of the video signal. On the result of the judgment, the additional information, such as the CGMS-A and XDS, is superimposed in a position where the CC signal can be provided in the predetermined cycle unit, such as 1GOP of the video signal.

As a result, for example, in superimposing the additional information, such as the CGMS-A and XDS, it is possible to almost or completely eliminate the delay of timing of displaying the CC data, such as captions or subtitles. Thus, it is possible to realize the superimposition of the additional information, more appropriately and quickly.

Moreover, it is not necessary to provide the memory device, such as a buffer memory, for storing the CC data and detecting the free space portion (or free space position) for an output device in the TV signal encoder. Thus, it is possible to realize the superimposition of the additional information, in a simpler structure. Thus, it is possible to further simplify the design and development of the information multiplexing apparatus.

(3) Study of Operation and Effect of Embodiment of Information

Multiplexing Apparatus of Present Invention

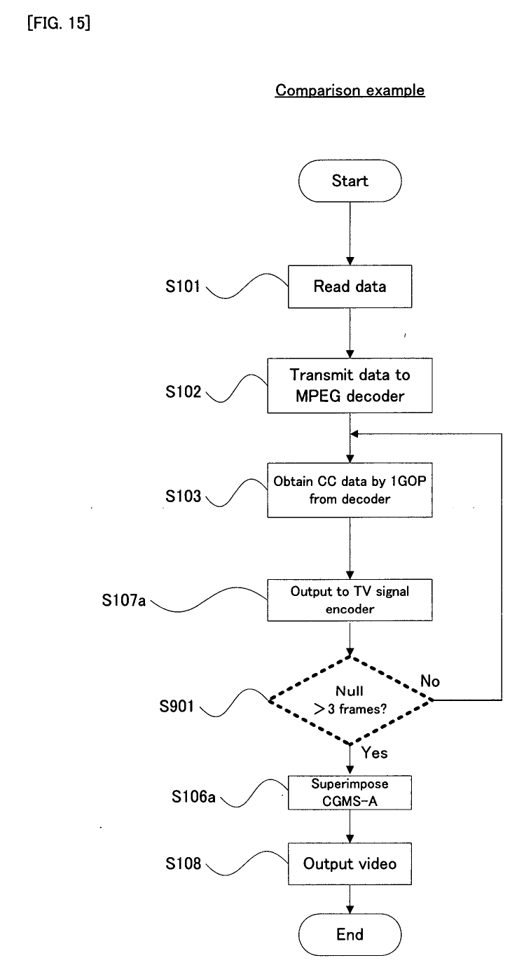

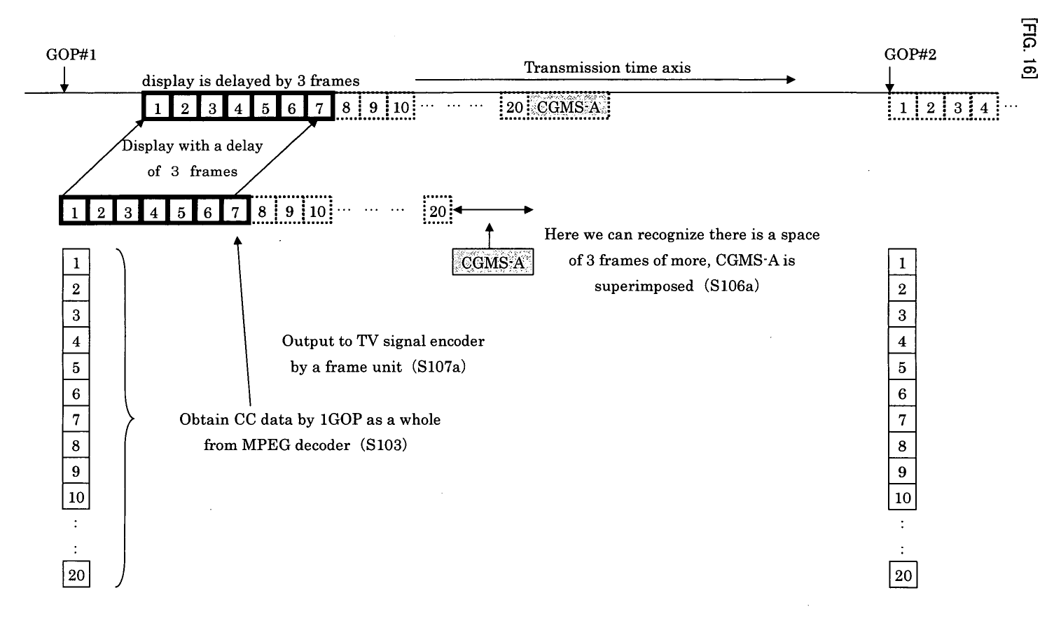

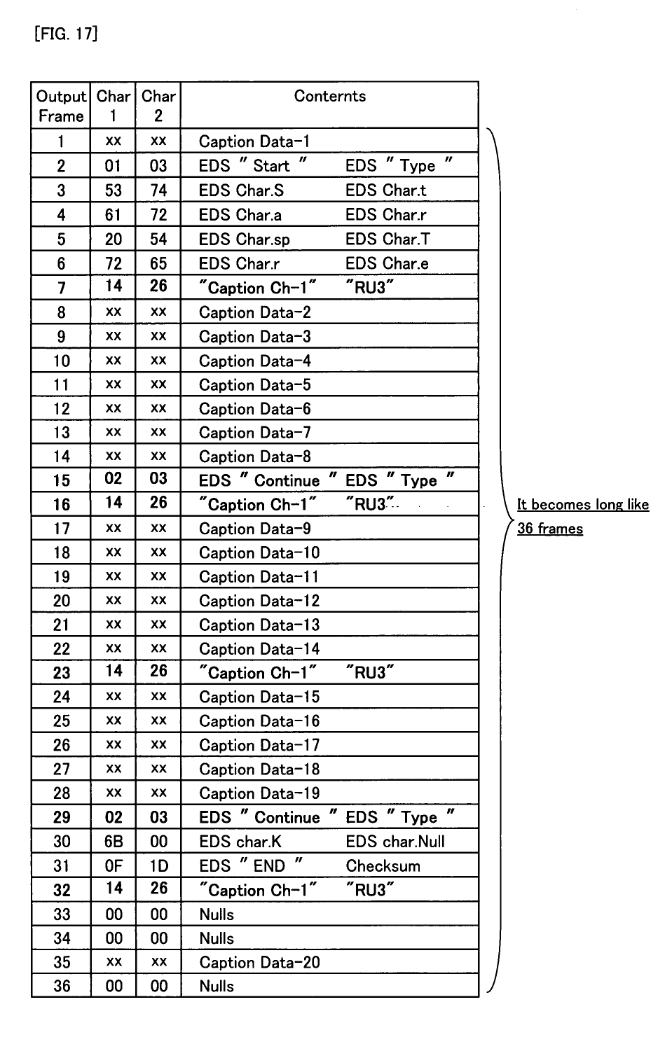

Next, with reference to FIG. 15 to FIG. 17, the operation and effect of the embodiment of the information multiplexing apparatus will be studied. FIG. 15 is a flowchart showing the operation principle in a comparison example. Incidentally, the same steps as those in FIG. 5 have the same step numbers, and the explanation thereof will be omitted. Moreover, if they are the same steps but have a different order, then the step numbers will get “a”, and their explanation will be omitted. FIG. 16 is a schematic diagram schematically showing the operation principle in the comparison example. Incidentally, in FIG. 15 and FIG. 16 described above, the additional data amount of the additional information, such as the CGMS-A, is 3 frames, but obviously, it is not limited to this. FIG. 17 is a table showing transition on the transmission time axis of XDS outputted by a frame unit, when a program title of a currently on-air program displays “Star Trek” which is one specific example of the additional information, in the obtaining operation of the information multiplexing apparatus in the comparison example. Incidentally, this comparison example indicates a method of superimposing the XDS in Line 21 of the video signal, defined by EIA/CEA-608-BNTSC (Electronics Industry Association).

As shown in FIG. 15, in the comparison example, the output to the TV signal encoder 108 (refer to a step 107a in FIG. 15 and FIG. 16) is performed before the superimposition of the CGMS-A. Then, on the memory device, such as a buffer memory, the CC data is stored or accumulated, and it is judged whether or not there is the free space portion (or free space position), such as Null, over 3 frames. On the basis of the result of the judgment, CSMS-A is superimposed (refer to a step S106a in FIG. 15 and FIG. 16).

Specifically, as shown in FIG. 17, in the “output frame #2”, a packet holding information about “control code, type code”=“01, 03” is transmitted, to thereby start the XDS. Then, if the CC data is transmitted for interruption, the XDS needs to be suspended. Specifically, in the “output frame “6”, “character code, character code”=“72, 65” is transmitted to thereby display “r” and “e” of the program title. Then, in the “output frame #7”, a “RU3 (Roll Up 3)” command is outputted. By this, it is prepared to go back to the output of the CC data. Then, in the “output frame #8” to the “output frame #14”, the CC data is interrupted.

Then, in the “output frame #15”, it is prepared to continue the XDS in response to “Null” of an input frame, for example.

Then, in the “output frame #16”, it is prepared to go back to the output of the CC data by outputting the “RU3” command in response to the CC data of an input frame, for example.

Then, in the “output frame #17” to the “output frame #22”, the CC data is outputted.

Then, in the “output frame #23”, it is prepared to continue the output of the CC data by outputting the “RU3” command in response to “Null” of the input frame.

Then, in the “output frame #24” to the “output frame #28”, the CC data is outputted.

Then, under the control of the controlling device of the information multiplexing apparatus in the comparison example, in the “output frame #29”, a packet holding information about “control code, type code” is “02, 03” is transmitted, to thereby restart the XDS. In the “output frame #30”, “character code, character code”=“6B, 00” is transmitted, and the last “k” and “Null” of the program title, which have not been displayed, are displayed.

Then, in the “output frame #31”, a packet holding information about “control code, type code” is “0F, 1D” is transmitted, to thereby end the XDS.

As described above, in the comparison example, the timing of displaying the CC data and the XDS is delayed. More specifically, in order to output the XDS, such as the program title “Star Trek”, in addition to the CC data, for example, 36 frames are necessary. As compared to the embodiment in FIG. 7 described above, it is delayed by 6 frames.

As described above, in the comparison example, the memory device is provided in order to avoid the collision between the CC data and the superimposition of the CGMS-A based on the XDS. Specifically, the memory device, such as a buffer memory, is provided for the output device, such as a TV signal encoder, which outputs the character information including the CGMS-A. Then, if the CC data is outputted in the course of the output of the CGMS-A, the output of the CGMS-A is suspended, and the CC data is outputted in priority. Thus, the superimposition of the additional information is suspended. If this suspension is performed, at least several frames of CC data in row need to be outputted. In other words, in the comparison example, since the CC data is stored or accumulated into the buffer memory in order to detect, e.g. continuous 3 frames of “Null”, it is delayed at least by about 2 frames. Then, after the frame holding the CC data gets disconnected, the output of the CGMS-A is restarted. Therefore, the timing of displaying the CGMS-A and the timing of displaying the CC data, such as captions or subtitles, are both delayed. Moreover, the buffer memory is provided for the output device, to thereby suspend the output of the CC data. Thus, the output control becomes complicated, which makes it hard to appropriately realize the superimposition of the additional information.

In contrast, according to the embodiment, as explained in FIG. 7 described above, it is possible to output the XDS in 1GOP, i.e. within 30 frames, in order to output the XDS, such as the program title “Star Trek”, in addition to the CC data.

Namely, according to the embodiment, it is judged whether or not the additional information, such as the CGMS-A and XDS, can be superimposed on the video signal, at the time point when the CC data is obtained in the predetermined cycle unit, such as 1GOP of the video signal. On the result of the judgment, the additional information, such as the CGMS-A and XDS, is superimposed in the position where the CC signal can be provided in the predetermined cycle unit, such as 1GOP of the video signal.

As a result, for example, in superimposing the additional information, such as the CGMS-A and XDS, it is possible to almost or completely eliminate the delay of timing of displaying the CC data, such as captions or subtitles. Thus, it is possible to realize the superimposition of the additional information, more appropriately and quickly.

Moreover, it is not necessary to provide the memory device, such as a buffer memory, for storing the CC data and detecting the free space portion (or free space position) for the output device in the TV signal encoder. Thus, it is possible to realize the superimposition of the additional information, in a simpler structure. Thus, it is possible to further simplify the design and development of the information multiplexing apparatus.

The present invention is not limited to the above-described embodiments, and various changes may be made, if desired, without departing from the essence or spirit of the invention which can be read from the claims and the entire specification. An information multiplexing apparatus and method, and a computer program for multiplexing control, all of which involve such changes, are also intended to be within the technical scope of the present invention.

### INDUSTRIAL APPLICABILITY

The information multiplexing apparatus and method, and the computer program according to the present invention can be applied to an information multiplexing apparatus for multiplexing the additional information, such as copyright protection information (CGMS-A: Copy Generation Management System-Analog) and character information (XDS: sXtended Data Service). Moreover, they can be applied to an information multiplexing apparatus or the like which is mounted on various computer equipment for consumer use or for commercial use, or which can be connected to various computer equipment.

1-11. (canceled)

12. An information multiplexing apparatus comprising:
an extracting device for extracting a closed caption signal, which is superimposed to hold character information included in a video signal;
a measuring device for measuring an actual data amount of the character information from the extracted closed caption signal, on the basis of a predetermined cycle unit of the video signal when the closed caption signal is extracted;
a superimposing device for superimposing additional information added to the video signal, on the video signal;
a judging deice for judging whether or not the additional information can be superimposed, on the basis of an allowable data amount of the character information which can be held in the predetermined cycle unit and the measured actual data amount when the closed caption signal is extracted; and
a controlling device for controlling said superimposing device to superimpose the additional information in a position where the closed caption signal can be provided in the predetermined cycle unit when the closed caption signal is extracted if the additional information can be superimposed as a result of the judgment.

13. The information multiplexing apparatus according to claim 12, wherein
said judging device judges whether or not the additional information can be superimposed, by comparing a free space with an additional data amount of the additional information, the free space being a difference between (i) the allowable data amount in the predetermined cycle unit and (ii) the actual data amount of the character information, and
said controlling device controls said superimposing device to superimpose the additional information in a free space portion where the closed caption signal can be provided.

14. The information multiplexing apparatus according to claim 13, wherein said judging device judges that the additional information can be superimposed if the difference is greater than the additional data amount.

15. The information multiplexing apparatus according to claim 12, wherein said controlling device controls said superimposing device to superimpose the additional information in certain time intervals if the measured actual data amount is zero.

16. The information multiplexing apparatus according to claim 12, wherein the predetermined cycle unit is a GOP (Group Of Picture) based on MPEG (Moving Picture Experts Group phase) standard.

17. The information multiplexing apparatus according to claim 12, wherein the additional information is information based on XDS (extended Data Service).

18. The information multiplexing apparatus according to claim 12, wherein the additional information includes information for copyright protection of the video signal.

19. The information multiplexing apparatus according to claim 18, wherein the additional information includes CCI (Copy Control Information).

20. The information multiplexing apparatus according to claim 12, wherein the additional information includes CDMS-A (Copy Generation Management System-Analog) information.

21. An information multiplexing method comprising:
an extracting process of extracting a closed caption signal, which is superimposed to hold character information included in a video signal;
a measuring process of measuring an actual data amount of the character information from the extracted closed caption signal, on the basis of a predetermined cycle unit of the video signal when the closed caption signal is extracted;
a superimposing process of superimposing additional information added to the video signal, on the video signal;
a judging process of judging whether or not the additional information can be superimposed, on the basis of an allowable data amount of the character information which can be held in the predetermined cycle unit and the measured actual data amount when the closed caption signal is extracted; and
a controlling process of controlling said superimposing device to superimpose the additional information in a position where the closed caption signal can be provided in the predetermined cycle unit when the closed caption signal is extracted if the additional information can be superimposed as a result of the judgment.

22. A computer program of instructions for multiplexing control and for tangibly embodying a program of instructions executable by a computer provided in an information multiplexing apparatus, the computer program making the computer function as at least one portion of an extracting device, a measuring device, a superimposing device, a judging device, and a controlling device, wherein
said information multiplexing apparatus comprising:
the extracting device for extracting a closed caption signal, which is superimposed to hold character information included in, in a vertical blanking interval of a video signal;
the measuring device for measuring an actual data amount of the character information from the extracted closed caption signal, on the basis of a predetermined cycle unit of the video signal when the closed caption signal is extracted;
the superimposing device for superimposing additional information added to the video signal, on the video signal;
the judging deice for judging whether or not the additional information can be superimposed, on the basis of an allowable data amount of the character information which can be held in the predetermined cycle unit and the measured actual data amount when the closed caption signal is extracted; and
the controlling device for controlling said superimposing device to superimpose the additional information in a position where the closed caption signal can be provided in the predetermined cycle unit when the closed caption signal is extracted if the additional information can be superimposed as a result of the judgment.
